(19) United States
(12) Patent Application Publication
(10) Pub. No.: US 2023/0364833 A1
(43) Pub. Date: Nov. 16, 2023

(54) METHOD FOR MANUFACTURING RESIN MOLDED ARTICLE

(71) Applicant: TOWA CORPORATION, Kyoto-shi, Kyoto (JP)

(72) Inventor: Yoshihisa KAWAMOTO, Uji-shi, Kyoto (JP)

(73) Assignee: TOWA CORPORATION, Kyoto-shi, Kyoto (JP)

(21) Appl. No.: 18/030,563

(22) PCT Filed: Sep. 28, 2021
(86) PCT No.: PCT/JP2021/035579

§ 371 Date: Apr. 6, 2023

(30) Foreign Application Priority Data
Oct. 6, 2020 (JP) 2020-168918

(51) Int. Cl. B29C 43/14; B29C 43/50

(52) U.S. Cl. CPC B29C 43/146; B29C 43/50; B29C 2043/3605

(57) ABSTRACT

The present invention is to improve the quality and appearance of a second molded product such as a secondary molded product obtained by further resin-molding a first molded product such as a primary molded product, for example. The present invention is a method for manufacturing a resin molded product in which a second molded product is obtained by further performing resin molding on a resin-molded first molded product using a first mold with a cavity formed and a second mold facing the first mold, the method including a disposing step of disposing the first molded product in the cavity and disposing a resin material on the first molded product, and a mold clamping step of clamping the first mold and the second mold after the disposing step.

### TECHNICAL FIELD

The present invention relates to a method for manufacturing a resin molded product.

### BACKGROUND ART

Conventionally, as shown in Patent Literature 1, there is a method for manufacturing a resin molded product, which is a secondary molded product, by further secondarily molding a primary molded product by resin sealing, the primary molded product being obtained by primary molding.

As an example of this manufacturing method, as illustrated in FIG. 5, a resin material is accommodated in a cavity of a lower mold for primary molding, a carrier is held in an upper mold, and the lower mold and the upper mold are clamped to obtain a primary molded product (primary molding step). Note that the primary molded product is peeled off from the carrier, and intermediate mounting such as rewiring is performed on an upper surface of the primary molded product. Then, the intermediately mounted primary molded product is turned upside down and sucked and held by the upper mold, the resin material is accommodated in the lower mold for secondary molding, and the lower mold for secondary molding and the upper mold are clamped to obtain a secondary molded product (secondary molding step).

### CITATION LIST

### Patent Literature

Patent Literature 1: WO 2017/160231 A

### SUMMARY OF THE INVENTION

### Technical Problem

However, in the manufacturing method described above, since the secondary molded product is obtained by sucking and holding the primary molded product and clamping the primary molded product, suction marks remain on the secondary molded product, the appearance of the secondary molded product is deteriorated, and the reliability of the product is affected.

Furthermore, when the resin material is accommodated in the cavity of the lower mold in the secondary molding, the resin material directly receives heat from the lower mold and the temperature of the resin material rises, so that the melting time of the resin material after clamping is limited. Then, the temperature of the resin material after clamping is less likely to be uniform, and the viscosity of the resin material varies. As a result, thermal stress is applied to the secondary molded product, which may cause warpage or unevenness or flow marks on the surface.

Therefore, the present invention has been made to solve the above problems, and it is a main object of the present invention to improve the quality and appearance of a second molded product such as a secondary molded product obtained by further resin-molding a first molded product such as a primary molded product.

### Solution to Problem

That is a method for manufacturing a resin molded product according to the present invention is a method for manufacturing a resin molded product, in which a second molded product is obtained by further performing resin molding on a resin-molded first molded product using a first mold with a cavity formed and a second mold facing the first mold, the method including: a disposing step of disposing the first molded product in the cavity and disposing a resin material on the first molded product; and a mold clamping step of clamping the first mold and the second mold after the disposing step.

### Advantageous Effects of Invention

According to the present invention configured as described above, for example, the quality and appearance of the second molded product such as a secondary molded product obtained by further resin-molding the first molded product such as a primary molded product can be improved.

### BRIEF DESCRIPTION OF THE DRAWINGS

FIG. 1 is a cross-sectional view schematically illustrating a configuration during primary molding of a resin molding apparatus according to an embodiment of the present invention.

FIG. 2 is a cross-sectional view schematically illustrating a configuration during secondary molding of the resin molding apparatus according to the embodiment.

FIG. 3 is a cross-sectional view schematically illustrating a state where a primary molded product and a resin material are disposed in a cavity and a cover plate is sucked and held by an upper mold in the embodiment.

FIG. 4 is a diagram schematically illustrating each step of a method for manufacturing a resin molded product of the embodiment.

FIG. 5 is a diagram schematically illustrating a conventional primary molding step and secondary molding step.

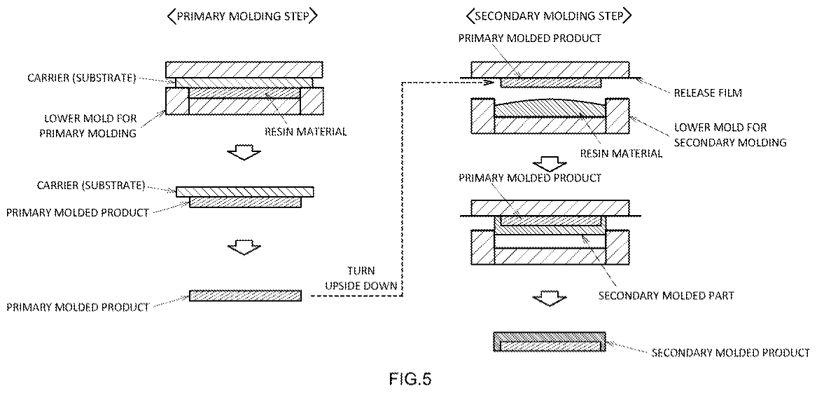

### REFERENCE SIGNS LIST

100 resin molding apparatus
J resin material
P1 primary molded product (first molded product)
P2 secondary molded product (second molded product)
2 lower mold (first mold)
2C cavity
3 upper mold (second mold)
3P mold surface
7 cover plate
8 release sheet

### DESCRIPTION OF EMBODIMENTS

Next, the present invention will be described in more detail with reference to examples. However, the present invention is not limited by the following description.

As described above, a method for manufacturing a resin molded product of the present invention is a method for manufacturing a resin molded product, in which a second molded product is obtained by further performing resin molding on a resin-molded first molded product using a first mold with a cavity formed and a second mold facing the first mold, the method including: a disposing step of disposing the first molded product in the cavity and disposing a resin material on the first molded product; and a mold clamping step of clamping the first mold and the second mold after the disposing step.

According to this method for manufacturing a resin molded product, the resin material is disposed on the first molded product in the cavity of the first mold, and the first mold and the second mold are clamped in this state. Therefore, it is not necessary to cause the first molded product to be sucked and held by the second mold, and no suction mark is generated in the second molded product.

Furthermore, since the resin material receives heat from the first mold via the first molded product, the temperature rise of the resin material becomes gentle, the melting time can be lengthened, and the uniformity of the temperature of the resin material can be improved. As a result, thermal stress is less likely to remain in the second molded product, and deformation such as warpage can be suppressed. Furthermore, since the uniformity of the temperature of the resin material is improved, it is possible to make the surface of the second molded product less likely to have spots and flow marks.

A mold (particularly a lower mold) for a second molded product such as a conventional secondary molded product is different from a mold for a first molded product such as a primary molded product. In this case, it is necessary to replace the mold in order to obtain the second molded product, and the replacement work becomes complicated. Furthermore, initial cost (capital investment) also increases.

In order to suitably solve this problem, it is desirable that the first mold and the second mold be configured using a mold of the first molded product.

In this case, it is conceivable to adjust a depth of the cavity of the first mold to be deeper during resin molding of the second molded product than during resin molding of the first molded product.

As specific embodiments of the disposing step, the following two are conceivable.

In a first aspect, the disposing step includes a step of disposing the first molded product in the cavity, and a step of disposing a resin material on the first molded product disposed in the cavity.

According to this aspect, the first molded product and the resin material are separately conveyed to the cavity, and the first molded product and the resin material can be reliably conveyed.

In a second aspect, the disposing step includes a step of disposing a resin material on the first molded product, and a step of disposing the first molded product on which the resin material is disposed in the cavity.

According to this aspect, the resin material and the first molded product can be disposed at once in the cavity.

For example, in a case where the second molding such as the secondary molding is performed using the mold of the first molding such as the primary molding, when an amount of shrinkage of the first molded product is small, the first molded product is unlikely to enter the cavity of the first mold during the molding of the second molded product.

In this case, it is desirable to further include a processing step of processing the first molded product before the disposing step.

By removing a part or a whole of an outer peripheral portion of the first molded product in this processing step, the first molded product can be easily disposed in the cavity of the first mold.

It is desirable to perform the mold clamping step in a state where a mold surface of the second mold is covered with a cover plate having rigidity to maintain its own shape.

With this configuration, the running cost and the disposal cost due to the use of the release film for the second mold can be reduced. Furthermore, since the cover plate has rigidity for maintaining its own shape and is made of a member capable of maintaining its own shape in a natural state, a cover plate conveyance mechanism that conveys the cover plate can be simplified. For example, the cover plate can be conveyed by a conveyance mechanism having the same configuration as the conveyance mechanism that conveys the first molded product. Moreover, since the cover plate is not soft like the release film and maintains the shape in a natural state in which no external force is applied other than gravity, wrinkles are not generated when the cover plate is attached to the mold surface of the second mold, and a mold structure is not complicated as in the case of using the release film.

It is preferable that a release sheet is attached to a surface of the cover plate in contact with the resin material.

With this configuration, the adhered resin can be removed only by peeling off the release sheet after resin molding, the cover plate can be reused, and cleaning work of the cover plate can be facilitated.

In order to suitably prevent the resin from adhering to the mold surface of the second mold, an outer shape of the cover plate in plan view is desirably larger than an outer shape of the cavity in plan view.

### One Embodiment of the Present Invention

Hereinafter, an embodiment of a method for manufacturing a resin molded product according to the present invention will be described with reference to the drawings. Note that any of the drawings illustrated below is schematically illustrated by omitting or exaggerating as appropriate for easy understanding. The same components are denoted by the same reference signs, and the description thereof will be omitted as appropriate.

In a method for manufacturing a resin molded product according to the present embodiment, for example, a first molded product resin-molded by compression molding is further subjected to resin molding by compression molding using a lower mold 2 as a first mold with a cavity 2C formed and an upper mold 3 as a second mold disposed opposite to the lower mold 2 to manufacture a second molded product as a resin molded product. Hereinafter, a primary molded product P1 obtained by the primary molding is referred to as a first molded product, and a secondary molded product P2 obtained by further resin-molding the primary molded product P1 is referred to as a second molded product.

Specifically, the method for manufacturing a resin molded product includes a primary molding step of performing resin molding on a substrate W as a carrier to obtain the primary molded product P1, and a secondary molding step of further performing resin molding on the primary molded product P1 obtained in the primary molding step to obtain the secondary molded product P2, and the above two steps are performed using the same resin molding apparatus 100.

<Configuration of Resin Molding Apparatus 100>

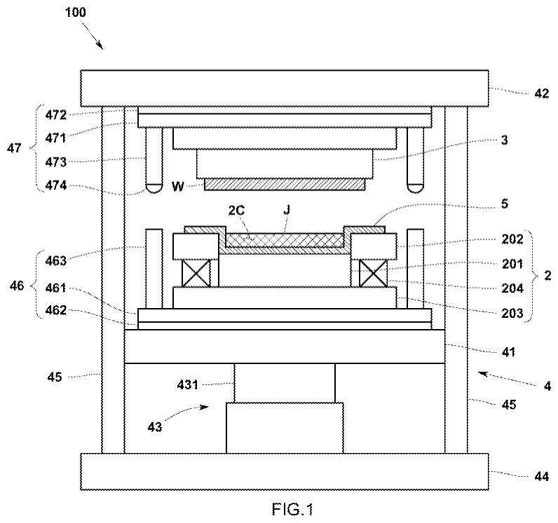

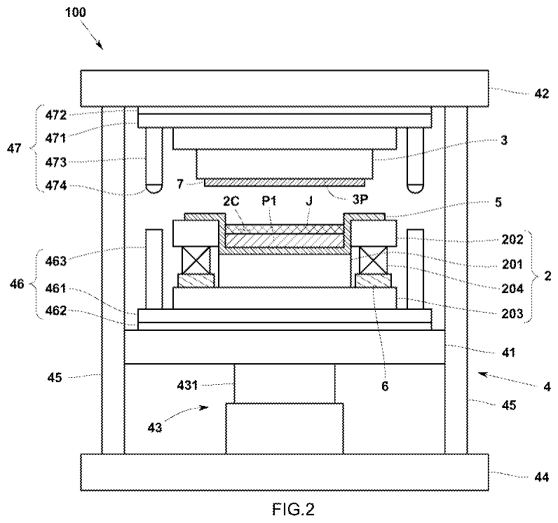

The resin molding apparatus 100 is of a compression molding type, and as illustrated in FIGS. 1 and 2, includes a lower mold 2 in which a cavity 2C is formed, an upper mold 3 disposed to face the cavity 2C of the lower mold 2, and a mold clamping mechanism 4 to which the lower mold 2 and the upper mold 3 are attached and which clamps the lower mold 2 and the upper mold 3.

The mold clamping mechanism 4 includes a movable platen 41 to which the lower mold 2 is attached, an upper fixed platen 42 to which the upper mold 3 is attached, and a drive mechanism 43 for moving the movable platen 41 up and down.

The lower mold 2 is attached to an upper surface of the movable platen 41, and is supported so as to be movable up and down by a plurality of support columns 45 provided upright on the lower fixed platen 44. Furthermore, the upper mold 3 is attached to the lower surface of the upper fixed platen, and the upper fixed platen 42 is fixed so as to face the movable platen 41 at upper end portions of the plurality of support columns 45.

The drive mechanism 43 is provided between the movable platen 41 and the lower fixed platen 44, and moves the movable platen 41 up and down to clamp the lower mold 2 and the upper mold 3. The drive mechanism 43 of the present embodiment is of a linear motion type that moves up and down the movable platen 41 using a ball screw mechanism 431 that converts rotation of a servomotor or the like into linear movement, but may be of a link type that transmits a power source such as a servomotor to the movable platen 41 using a link mechanism such as a toggle link.

A lower mold holding portion 46 is provided between the lower mold 2 and the movable platen 41. The lower mold holding portion 46 includes a heater plate 461 that heats the lower mold 2, a heat insulating member 462 provided on a lower surface of the heater plate 461, and a side wall member 463 provided on an upper surface of the heater plate 461 and surrounding a periphery of the lower mold 2. Furthermore, an upper mold holding portion 47 is provided between the upper mold 3 and the upper fixed platen 42. The upper mold holding portion 47 includes a heater plate 471 that heats the upper mold 3, a heat insulating member 472 provided on an upper surface of the heater plate 471, a side wall member 473 provided on a lower surface of the heater plate 471 and surrounding a periphery of the upper mold 3, and a seal member 474 provided at a lower end of the side wall member 473. Then, at the time of clamping by the drive mechanism 43, the side wall member 463 and the seal member 474 of the side wall member 473 come into close contact with each other, and a space that accommodates the lower mold 2 and the upper mold 3 is blocked from the outside air. Note that the seal member may be provided not at the lower end of the side wall member 473 but at an upper end of the side wall member 463.

The lower mold 2 is used in both the primary molding step and the secondary molding step. The cavity 2C of the lower mold 2 accommodates a resin material J in the primary molding step (see FIG. 1), and accommodates the primary molded product P1 and the resin material J in the secondary molding step (see FIG. 2). Note that as the resin material J, for example, a granular resin can be used.

Specifically, the lower mold 2 includes a bottom surface member 201 that is a single member forming, for example, a planar bottom surface of the cavity 2C, and a side surface member 202 surrounding the bottom surface member 201. The cavity 2C is formed by an upper surface of the bottom surface member 201 and an inner peripheral surface of the side surface member 202.

The side surface member 202 is provided to be vertically movable relative to the bottom surface member 201. Specifically, a base plate 203 of the lower mold 2 is supported by a plurality of elastic members 204 such as coil springs. Furthermore, the lower mold 2 of the present embodiment is covered with a release film 5 in order to improve releasability of the primary molded product P1 and the secondary molded product P2. Furthermore, an air vent (not illustrated) for discharging air and gas may be provided on an upper surface of the side surface member 202 (a contact surface between the side surface member 202 and the substrate W).

Here, the lower mold 2 is configured to be adjustable such that a depth of the cavity 2C at the time of resin molding (secondary molding step) of the secondary molded product P2 is deeper than a depth of the cavity 2C at the time of resin molding (primary molding step) of the primary molded product P1.

Specifically, as illustrated in FIG. 2, it is conceivable to adjust the depth of the cavity 2C by adjusting a relative height of the side surface member 202 with respect to the bottom surface member 201 by interposing a spacer member 6 such as a shim between the base plate 203 of the lower mold 2 and the elastic member 204. For example, it is conceivable that the spacer member 6 is not interposed between the base plate 203 and the elastic member 204 in the primary molding step (see FIG. 1), and the spacer member 6 is interposed between the base plate 203 and the elastic member 204 in the secondary molding step (see FIG. 2), whereby the depth of the cavity 2C in the secondary molding step is made deeper than the depth of the cavity 2C in the primary molding step. In addition, the depth of each cavity 2C may be adjusted by changing a thickness of the spacer member 6 in the primary molding step and the secondary molding step.

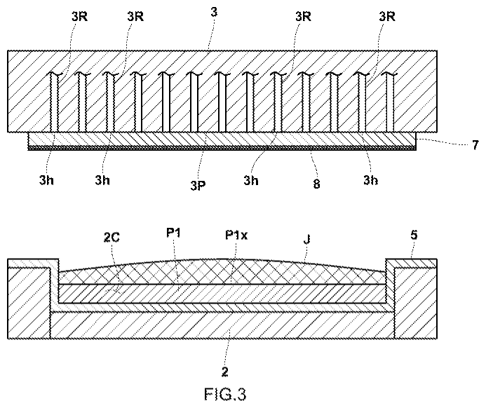

The upper mold 3 is used in both the primary molding step and the secondary molding step. A mold surface 3P of the upper mold 3 has a planar shape, and in the primary molding step, a back surface of the substrate W is sucked and held (see FIG. 1), and in the secondary molding step, a cover plate 7 as a substitute for the release film is sucked and held (see FIG. 2). Here, as illustrated in FIG. 3, a suction port 3h is formed on a lower surface of the upper mold 3, and a suction flow path 3R connected to the suction port 3h is formed inside the upper mold 3.

The suction flow path 3R is connected to an external suction device (not illustrated). The cover plate 7 used at the time of secondary molding covers the mold surface 3P of the upper mold 3 so that the resin material J does not adhere to the mold surface 3P of the upper mold 3 as particularly illustrated in FIG. 3. The cover plate 7 of the present embodiment has rigidity to maintain its own shape, and is made of a member having rigidity to maintain its own shape (for example, a flat plate shape) in a natural state in which no external force is applied other than gravity. The cover plate 7 is made of, for example, metal, resin, or paper.

Furthermore, a thickness of the cover plate 7 depends on the material, but is usually preferably about 0.2 mm to about 0.5 mm. When the thickness is less than about 0.2 mm, it may be difficult to maintain its own shape in the above natural state. On the other hand, when the thickness is larger than about 0.5 mm, it may be difficult to maintain its own shape in a natural state because its own weight cannot be fully supported depending on the size, and operability is deteriorated due to an increase in cost and weight. In particular, in the case of paper, when the thickness is larger than about 0.5 mm, a deformation amount due to being pressed by a molding pressure increases, and it is difficult to secure the flatness of the resin molded portion of the resin molded product.

Here, “having rigidity that maintains its own shape” means that the cover plate 7 is not deformed by its own weight in a cantilevered state in which one end portion of the cover plate 7 is supported and the one end portion is set as a fixed end, or the strength is set to such an extent that the amount of deformation due to its own weight can be ignored in practical use. Alternatively, “having rigidity that maintains its own shape” means that the strength is set to such an extent that the cover plate 7 can maintain a standing state in a state where the cover plate 7 is vertically supported at the lower end. Note that “having rigidity that maintains its own shape” means to exclude a release film that is easily deformed when lifted up and cannot maintain its own shape and can be wrinkled.

Examples of the metal material include a flat plate made of stainless steel or copper. Examples of the resin material include plastic flat plates such as glass epoxy resins. Examples of the paper material include thick paper such as dust-proof paper. Since the mold (lower mold 2, upper mold 3) is heated, the cover plate 7 preferably has heat resistance.

Here, as illustrated in FIG. 3, a release sheet 8 is desirably attached to the surface of the cover plate 7 that is in contact with the resin material J. Here, in a case where the release sheet 8 has a multilayer structure, the release sheet 8 on an outermost side can be peeled off after the secondary molding step to be used in the next secondary molding step, and in a case where the release sheet 8 has a single layer structure, the release sheet 8 can be peeled off after the secondary molding step and a new release sheet 8 can be attached to the cover plate 7 to be used in the next secondary molding step.

Moreover, an outer shape of the cover plate 7 in a plan view is larger than an outer shape of the cavity 2C in a plan view. For example, in a case where the cavity 2C has a rectangular shape, it is conceivable to use a rectangular cover plate 7 having a larger outer shape than the cavity 2C, and in a case where the cavity 2C has a circular shape, it is conceivable to use a circular cover plate 7 having a larger outer shape than the cavity 2C. Since the cover plate 7 is larger than the cavity 2C in this manner, it is possible to prevent the molten resin material J from coming into contact with the mold surface 3P of the upper mold 3.

In addition, it is conceivable that the cover plate 7 has the same shape as the substrate W used in the primary molding step in a plan view. As a result, the cover plate 7 can be positioned using positioning pins (not illustrated) of the substrate W provided in the upper mold 3.

<Details of Method for Manufacturing Resin Molded Product>

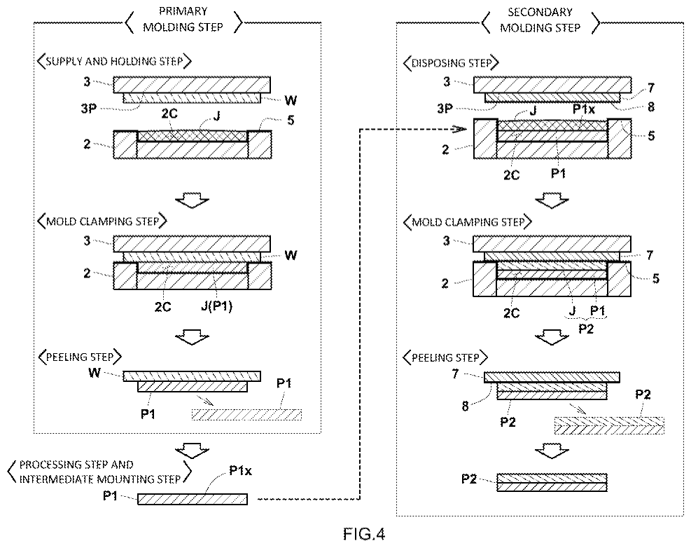

Next, a method for manufacturing a resin molded product using the resin molding apparatus 100 will be described in detail with reference to FIG. 4.

<A. Primary Molding Step>

The primary molding step of the present embodiment includes a supply and holding step of supplying the resin material J to the cavity 2C of the lower mold 2 and sucking and holding the substrate W as a carrier to the upper mold 3, a mold clamping step of clamping the lower mold 2 and the upper mold 3 and performing resin molding on the substrate W, and a peeling step of peeling the primary molded product P1 obtained by resin molding from the substrate W.

<A-1. Supply and Holding Step>

First, the resin material J weighed by a resin material supply mechanism (not illustrated) is supplied to the cavity 2C of the opened lower mold 2. At this time, it is conceivable that the resin material supply mechanism supplies the resin material J to the cavity 2C by placing the weighted resin material J on the release film 5 and bringing the release film 5 on which the resin material J is placed into close contact with the cavity 2C. In addition, the release film 5 may be brought into close contact with the cavity 2C in advance, and the resin material supply mechanism may supply the weighted resin material J to the cavity 2C to which the release film 5 is brought into close contact.

Furthermore, the substrate W is conveyed to the mold surface 3P of the opened upper mold 3 by a conveyance mechanism (not illustrated) to be sucked and held. At this time, the substrate W is positioned by a positioning pin (not illustrated) provided on the mold surface 3P of the upper mold 3.

<A-2. Mold Clamping Step>

Then, after the resin material J is melted in the lower mold 2, the lower mold 2 and the upper mold 3 are clamped by the mold clamping mechanism 4 with a predetermined clamping pressure. After a predetermined time has elapsed, the lower mold 2 is lowered by the mold clamping mechanism 4 to open the lower mold 2 and the upper mold 3. As a result, the flat plate-shaped primary molded product P1 is resin-molded on the substrate W.

<A-3. Peeling Step>

After the mold clamping step, the substrate W (the substrate W having the primary molded product P1) molded with resin is received from the opened upper mold 3 by the conveyance mechanism (not illustrated). Then, the primary molded product P1 is peeled off from the substrate W by a peeling mechanism (not illustrated). The peeled primary molded product P1 is accommodated in a primary molded product accommodating portion (not illustrated) or the like. Note that after the mold clamping step, the release film 5 of the lower mold 2 is also separately removed. In this way, the primary molding step ends.

Here, the method for manufacturing a resin molded product of the present embodiment includes, between the primary molding step and the secondary molding step, a processing step of removing a part or a whole of an outer peripheral portion of the primary molded product P1 in accordance with the secondary molding step to be described later in a case where a shrinkage amount of the primary molded product P1 is small, and an intermediate mounting step of performing intermediate mounting such as rewiring on the primary molded product P1.

<B. Processing Step>

An outer shape of the primary molded product P1 peeled off in the peeling step and cooled to room temperature is measured. In a case where the resin shrinkage amount of the primary molded product P1 is small, the outer peripheral portion of the primary molded product P1 is removed by polishing or the like as necessary. Note that the outer peripheral portion of the primary molded product P1 can be uniformly removed by polishing or the like without measuring the outer shape of the primary molded product P1. This enables the primary molded product P1 to be reliably disposed in the cavity 2C in the secondary molding step. This processing step may be performed using a processing device different from the resin molding apparatus 100 described above, but may be performed inside the resin molding apparatus 100 by providing the resin molding apparatus 100 with a processing function.

<C. Intermediate Mounting Step>

Intermediate mounting such as rewiring (not illustrated) is performed on one surface (for example, a surface peeled off from the substrate W) of the primary molded product P1 peeled off from the substrate W. As a result, an intermediate mounting surface P1x is formed on the primary molded product P1. It is conceivable that this intermediate mounting step is performed using an intermediate mounting device different from the resin molding apparatus 100 described above, but the intermediate mounting step may be performed inside the resin molding apparatus 100 by providing the resin molding apparatus 100 with an intermediate mounting function.

<D. Secondary Molding Step>

The secondary molding step of the present embodiment is performed after the intermediate mounting step, and before the secondary molding step is performed, a depth of the cavity 2C of the lower mold 2 of the resin molding apparatus 100 is adjusted based on a set value of a thickness of the secondary molded product P2. Note that as illustrated in FIG. 2, it is conceivable to adjust the depth of the cavity 2C by interposing the spacer member 6 such as a shim between the base plate 203 of the lower mold 2 and the elastic member 204.

Specifically, the secondary molding step includes a disposing step in which the primary molded product P1 is disposed in the cavity 2C and the resin material J is disposed on the primary molded product P1, a holding step in which the cover plate 7 is held by the upper mold 3, a mold clamping step in which the lower mold 2 and the upper mold 3 are clamped and the resin is molded into the primary molded product P1, and a peeling step in which the secondary molded product P2 obtained by the resin molding is peeled off from the cover plate 7.

<D-1. Disposing Step>

This disposing step includes a step of disposing the primary molded product P1 in the cavity 2C, and a step of disposing the resin material J weighed by the resin material supply mechanism (not illustrated) on the primary molded product P1 disposed in the cavity 2C. Here, the primary molded product P1 disposed in the cavity 2C is disposed such that its intermediate mounting surface P1x faces upward. Furthermore, in a state where the resin material J is disposed on the primary molded product P1, the resin material J starts melting by receiving heat from the lower mold 2 via the primary molded product P1.

Note that in the step of disposing the primary molded product P1 in the cavity 2C, it is conceivable that the primary molded product P1 is placed on the release film 5, the release film 5 on which the primary molded product P1 is placed is sucked to the cavity 2C, and at the same time, the primary molded product P1 is disposed in the cavity 2C.

In addition, the disposing step may include a step of disposing the weighed resin material J on the primary molded product P1 and a step of disposing the primary molded product P1 in which the resin material J is disposed in the cavity 2C.

Note that in the step of disposing the primary molded product P1 on which the resin material J is disposed in the cavity 2C, it is conceivable that the primary molded product P1 on which the resin material J is disposed is placed on the release film 5, the release film 5 on which the primary molded product P1 is placed is sucked to the cavity 2C, and at the same time, the primary molded product P1 on which the resin material J is disposed is disposed in the cavity 2C.

<D-2. Holding Step>

In the holding step, the cover plate 7 is conveyed to the mold surface 3P of the opened upper mold 3 by a conveyance mechanism (not illustrated) to be sucked and held. At this time, the cover plate 7 is positioned by a positioning pin (not illustrated) provided on the mold surface 3P of the upper mold 3. The cover plate 7 of the present embodiment has the same shape as the substrate W. and is positioned using a positioning pin of the substrate W.

<D-3. Mold Clamping Step>

Then, after the resin material J is melted in the lower mold 2, the lower mold 2 and the upper mold 3 are clamped by the mold clamping mechanism 4 with a predetermined clamping pressure. After a predetermined time has elapsed, the lower mold 2 is lowered by the mold clamping mechanism 4 to open the lower mold 2 and the upper mold 3. As a result, the flat plate-shaped secondary molded product P2 is resin-molded on the cover plate 7. The secondary molded product P2 has substantially the same outer shape as the primary molded product P1 in a plan view. Note that the primary molded product P1 that has been thermally shrunk or has its periphery removed is overmolded in a case where there is a gap between the primary molded product P1 and an inner peripheral surface of the cavity 2C (an inner peripheral surface of the side surface member 202) in a state where the primary molded product P1 is accommodated in the cavity 2C.

<D-4. Peeling Step>

After the mold clamping step, the cover plate 7 (the cover plate 7 having the secondary molded product P2) formed of resin is received from the opened upper mold 3 by the conveyance mechanism (not illustrated). Then, the secondary molded product P2 is peeled off from the cover plate 7 by a peeling mechanism (not illustrated). The peeled secondary molded product P2 is accommodated in a secondary molded product accommodating portion (not illustrated) or the like. Note that after the mold clamping step, the release film 5 of the lower mold 2 is also separately removed. In this way, the secondary molding step is completed.

### Effects of Present Embodiment

According to the resin molding apparatus 100 of the present embodiment, the resin material J is disposed on the primary molded product P1 in the cavity 2C of the lower mold 2, and the lower mold 2 and the upper mold 3 are clamped in this state. Therefore, it is not necessary to cause the primary molded product P1 to be sucked and held by the upper mold 3, and no suction mark is generated in the secondary molded product P2.

Furthermore, since the resin material J receives heat from the lower mold 2 via the primary molded product P1, the temperature rise of the resin material J becomes gentle, the melting time can be lengthened, and the uniformity of the temperature of the resin material J can be improved. As a result, thermal stress is less likely to remain in the secondary molded product P2, and deformation such as warpage can be suppressed. Furthermore, since the uniformity of the temperature of the resin material J is improved, it is possible to make the surface of the secondary molded product P2 less likely to have spots and flow marks.

Moreover, in the present embodiment, since the same molds 2 and 3 are used for the primary molding and the secondary molding, it is possible to eliminate the need for replacement work of the molds between the primary molding and the secondary molding, and it is also possible to suppress initial cost (capital investment).

Moreover, since the mold surface 3P of the upper mold 3 is covered with the cover plate 7 during the secondary molding, it is possible to prevent the resin from adhering to the mold surface 3P of the upper mold 3 without using a release film for the upper mold 3. Therefore, the running cost and the disposal cost due to the use of the release film for the upper mold 3 can be reduced.

In addition, since the cover plate 7 has rigidity for maintaining its own shape and is made of a member capable of maintaining its own shape in a natural state, the cover plate conveyance mechanism that conveys the cover plate 7 can be simplified. For example, the cover plate 7 can be conveyed by a conveying mechanism having the same configuration as the conveying mechanism that conveys the substrate W and the primary molded product. Moreover, since the cover plate 7 is not soft like the release film and maintains the shape in a natural state in which no external force is applied other than gravity, wrinkles are not formed when the cover plate 7 is attached to the mold surface 3P of the upper mold 3, and the mold structure is not complicated as in the case of using the release film.

Furthermore, since the release sheet 8 is attached to the surface of the cover plate 7 in contact with the resin material P, the attached resin can be removed only by removing the release sheet 8 after the secondary molding, and cleaning work of the cover plate 7 can be facilitated.

### Other Modified Embodiments

Note that the present invention is not limited to the above embodiment.

For example, in the above embodiment, the case where the first molded product is the primary molded product P1 and the second molded product is the secondary molded product P2 has been exemplified, but the first molded product may be a secondary molded product and the second molded product may be a tertiary molded product, or the first molded product may be a tertiary molded product and the second molded product may be a quaternary molded product. That is, the present invention is applicable even when the first molded product is a secondary or higher molded product.

Furthermore, in the above embodiment, the cover plate 7 is sucked and held by the upper mold 3 during the secondary molding. However, the cover plate 7 may be held by a clamp mechanism in addition to the suction and holding configuration. Alternatively, the cover plate 7 may be held by the clamp mechanism instead of the suction and holding configuration. Here, the clamp mechanism is provided around the upper mold 3 and holds the cover plate 7 to be caught on a lower surface of an outer edge portion of the cover plate 7.

In addition, the cover plate 7 itself may be formed by overlapping a plurality of peelable films, and the outermost film of the cover plate 7 may be peeled off and used for each secondary molding.

In the above embodiment, the primary molding step includes the processing step, but the primary molding step may not include the processing step. Furthermore, by removing the outer peripheral portion of the primary molded product in the processing step, an amount of resin molding (an amount of overmolding) around the primary molded product at the time of secondary molding may be adjusted.

In the above embodiment, the primary molding step and the secondary molding step are performed by the same resin molding apparatus, but the primary molding step and the secondary molding step may be performed using different resin molding apparatuses.

In the above embodiment, the resin material is a granular resin, but may be a liquid resin.

In addition, the present invention is not limited to the above embodiments, and it goes without saying that various modifications can be made without departing from the gist of the present invention.

### INDUSTRIAL APPLICABILITY

According to the present invention, it is possible to improve the quality and appearance of a second molded product such as a secondary molded product obtained by further resin-molding a first molded product such as a primary molded product.

1. A method for manufacturing a resin molded product, in which a second molded product is obtained by further performing resin molding on a resin-molded first molded product using a first mold with a cavity formed and a second mold facing the first mold, the method comprising:
making a state in which the first molded product is disposed in the cavity and a resin material is disposed on the first molded product; and
clamping the first mold and the second mold after the state.

2. The method for manufacturing a resin molded product according to claim 1, wherein the first mold and the second mold are configured using a mold of the first molded product.

3. The method for manufacturing a resin molded product according to claim 2, wherein a depth of the cavity of the first mold is adjusted to be deeper during resin molding of the second molded product than during resin molding of the first molded product.

4. The method for manufacturing a resin molded product according to claim 1, wherein
the state includes:
the first molded product is disposed in the cavity; and
a resin material is disposed on the first molded product disposed in the cavity.

5. The method for manufacturing a resin molded product according to claim 1, wherein
the state includes:
a resin material is disposed on the first molded product; and
the first molded product is disposed on which the resin material is disposed in the cavity.

6. The method for manufacturing a resin molded product according to claim 1, further comprising processing the first molded product before the state.

7. The method for manufacturing a resin molded product according to claim 1, wherein the clamping of the first mold and the second mold is performed in a state where a mold surface of the second mold is covered with a cover plate having rigidity to maintain its own shape.

8. The method for manufacturing a resin molded product according to claim 7, wherein a release sheet is attached to a surface of the cover plate in contact with the resin material.

9. The method for manufacturing a resin molded product according to claim 7, wherein an outer shape of the cover plate in a plan view is larger than an outer shape of the cavity in a plan view.
